(19) United States
(12) Patent Application Publication
(10) Pub. No.: US 2008/0013402 A1
(43) Pub. Date: Jan. 17, 2008

(54) System and assembly for dissolving powders and/or diluting concentrated liquids to obtain a solution having desired concentrations of a plurality of solutes

(76) Inventor: Carl Kelley, Golden, CO (US)

Correspondence Address: CLARK & BRODY, 1090 VERMONT AVENUE, NW, SUITE 250, WASHINGTON, DC, 20005, US

(21) Appl. No.: 11/822,621

(22) Filed: Jul. 9, 2007

Related U.S. Application Data
(60) Provisional application No. 60/818,963, filed on Jul. 7, 2006.

(51) Int. Cl. B01F 3/12; B01F 13/10

(52) U.S. Cl. 366/206

(57) ABSTRACT

A system and assembly for mixing powder and liquid into a solution and maintaining the powder in the solution is disclosed. A mixing device operates an agitator to mix the powder and the liquid at a certain power level. The mixing device operates for a period of time, and then turns off. A maintenance device then operates another agitator to maintain the powder in the solution to reduce the amount of residue or sediment that settles in the container. The maintenance device operates at a lower power level than the mixing device. A dilution chamber is connected to the container to further dilute the solution for use in commercial or industrial applications.

### CROSS REFERENCE TO RELATED APPLICATION

This application claims the benefit of U.S. Provisional Application Ser. No. 60/818,963, which was filed on Jul. 7, 2006.

### TECHNICAL FIELD

The present invention relates to systems for mixing and maintaining blended solutions for storage and use in commercial or industrial applications. More particularly, the present invention relates to a system for dissolving a powder or diluting a concentrated liquid in a solvent liquid, preferably water, whereby the powder is dissolved or maintained in suspension until further diluted.

### BACKGROUND

Cleaning products, such as soaps and detergents, for industrial and commercial applications are often provided in powdered or concentrated form to reduce the costs for transportation and storage. Compounded cleaning products typically comprise a mixture of solids or mixtures of solids and liquids, and the mixture of solids is typically dissolved in water (or other solvent) prior to use to provide a concentrated cleaning solution. This concentrated solution is then diluted further with water (or other solvent) for application to the object to be cleaned. While solid compounds, or compounded mixtures can be used directly, the vehicle wash industry, as in industrial cleaning, typically dilutes a concentrated solution with water through a mixing metering device such as a venturi-type dispenser sold under the trademark HydroMinder to provide a solution that can be applied directly to the vehicle, surface or object to be cleaned as a spray. The preparation and storage of such a concentrated solution from a dry, compounded cleaner mixture or a concentrated solution presents the problem of maintaining all of the components in the desired concentrations in the final solution applied to the object to be cleaned.

While consumer products are often provided as ready-to-use solutions, compounded cleaning mixtures for industrial uses are typically provided as (a) dry or nearly dry powders, (b) concentrated liquid solutions, or (c) concentrated suspensions. The dry powders and concentrated suspensions, though containing more active ingredients per volume, must be dissolved or diluted on site to prepare a concentrated solution.

A primary reason for providing these products in dry or concentrated form is that it reduces shipping and storage costs, but a disadvantage is that they must be dissolved or diluted further before use. Another disadvantage is that the respective concentration of each component in a concentrated solution is limited by its solubility, which often results in a less-active product because desired components having limited solubility cannot effectively be used and may also require shipping and storage of water, or other solvents. As well, providing the cleaning equipment with a sufficient supply of concentrate to meet usage requirements for a period of days or even weeks between refilling presents yet another problem.

Various methods of preparing solutions suitable for metering or direct use have been used and/or described in the prior art. For example, several methods dissolve a powder or compressed powder block by spraying water or other solvent on the powder that is maintained out of contact with the solution. The desired concentrations of the various components are maintained by monitoring the resultant solution by measuring the conductance, pH, optical properties, or other properties and by adding water or other solvents as required. Care must be taken, however, to avoid differential solution of the components of the powder into the solution to avoid altering the composition of the solution compared to the powder.

Others have simply added the powder in excess to the mixing chamber, allowing the un-dissolved portion to settle to the bottom ad be dissolved as more water (solvent) is added to maintain an unpredictable concentration. Unless extreme care is taken to create the exact mixture in which all components reach saturation at the same time, the method of simply adding excess powder results in differential solution of the components and provides a concentrated solution with a composition differing significantly from that of the original formulated powder.

Another problem is that when dissolving powered products, the powder may settle to form a residue or sediment at the bottom of a container. To prevent the settlement, the super-saturated solution must be constantly agitated until drawn out, and a motor is typically placed on the container to operate a propeller, or agitator, within the container to prevent settling. The motor, however, may be subjected to constant usage for mixing and agitating the solutions, or operated at speeds and power levels not required to maintain the mixed ingredients. The initial mixing of the powder and water may require more horsepower from the motor than the subsequent mixing that prevents sedimentation, and such a motor may not be reliably used for the lower order mixing of the solution as it can burn out or fail due to constant usage. Further, the motor may draw additional power, which further increases costs.

In addition stoppages may occur in a drawtube and other tubular element that draw the super-saturated solution out of the container. For example, a tube may provide the concentrate to one or more injectors for further dilution and supply to the spray equipment. Due to the heavy concentration of the powdered soap in the solution, residue may build up at low points in the tubes, such as elbows, or in the injectors, which prevents adequate flow of the solution and eventually chokes flow in the tube. Thus, the convenience of providing solutions in a super-saturated or concentrated states is offset by the above problems in maintaining and using the solution.

### SUMMARY OF THE INVENTION

The invention provides a method and apparatus for creating a suspension of a powder in a liquid, preferably a powdered detergent in water, and maintaining the suspension without differential settling of components of the powder, thus maintaining the original ratio of the components for further dilution of this suspension to create a solution suitable for metering or using directly. An apparatus according to the invention incorporates the preparation and maintenance of the suspension and dilution to a concentrated solution in one container, such as a 55 gallon drum, with attached mixing motors and control electronics.

The initial suspension is prepared by providing a predetermined ratio of powder-to-water (solvent) and then mixing thoroughly with sufficient power and speed to create a saturated or nearly saturated solution with the un-dissolved portion in suspension, thus maintaining the initial ratio of components in the original mixture. The maintenance of the suspension is through the use of a separate smaller mixer and/or intermittently mixing with a single mixer by the use of a timer. The initial mixer and/or the maintenance mixer can be any device, including pumps, paddle mixers, plate agitators, vibrators, bubble mixers, sonic mixers, ultra sonic mixers, and the initial mixer and maintenance mixer may be of the same or different types. Because the suspension is sufficiently concentrated, the second dilution results in a concentrated solution.

It is further taught that metering of such a suspension is best done through short flow lines with no “sags” in order to avoid plugging by settlement of the suspension in the line. The preferred method is to use a small diameter vertical line without reliance on check valves to keep the line full. This then allows for almost immediate draw of the suspension into the dilution tank for the continuous preparation of the concentrated solution “on the run”.

It is further taught that two or more liquids with limited solubility in each other can be substituted for the powder/solvent example. Further it is noted that downstream injection or addition of various enhancers, boosters, etc is not excluded and is to be anticipated.

The disclosed embodiments are directed to a system and assembly for mixing and maintaining a blended solution of powder and liquid, such as powder, for storage that prevents the problems discussed above. Two devices, such as motors, are used, and may be referred to as a mixing motor and a maintenance motor. The mixing motor may be larger than the maintenance motor. After loading the powder and the water into a container, the mixing motor is run for a period of time to initially blend the two ingredients into the solution. Preferably, the period of time is about 15 minutes. The maintenance motor then is operated at a lesser horsepower rating according to an intermittent schedule to keep the powder and the water in the solution. The solution is in a super-concentrated or super-saturated state.

According to the disclosed embodiments, a storage system for a blended powder and liquid solution is disclosed. The storage system includes a container to store the blended solution. The storage system also includes a mixing device attached to the container to mix powder and liquid with a first agitator to form the blended solution. The mixing device is to run at a first power level for a period of time. The storage system also includes a maintenance device having a smaller power output than the mixing device and attached to the container to maintain the powder in the blended solution with a second agitator. The maintenance device is to operate according to a schedule at a second power level. The second power level is lower than the first power level.

According to the disclosed embodiments, an assembly for attachment to a container to mix and maintain a blended powder and liquid solution within the container also is disclosed. The assembly includes a mixing device having a first agitator to mix powder and water to generate the solution. The mixing device outputs a first power level to the first agitator. The assembly also includes a maintenance device having a second agitator to maintain the powder in the solution by operating on an intermittent basis. The maintenance device outputs a second power level to the second agitator.

According to the disclosed embodiments, a system to provide a liquid product also is disclosed. The system includes a container to store a solution of powder and liquid. The system also includes a mixing device connected to an agitator to mix the powder and liquid into the solution. The system also includes a maintenance device connected to another agitator to maintain the powder in the solution. The maintenance device operates at a lower power level than the mixing device. The system also includes a dilution chamber to draw the solution from the container and to dilute the solution with the liquid into a product having a less concentrated state for the powder.

According to the disclosed embodiments, a method for mixing and maintaining a solution also is disclosed. The method includes mixing powder and liquid in a container to form a solution using a mixing device having a first power output. The method also includes turning off the mixing device after a period of time. The method also includes maintaining the powder in the solution using a maintenance device having a second power output. The second power output is lower than the first power output by turning the maintenance device on and off according to a schedule.

According to the disclosed embodiments, a dilution chamber also is disclosed. The dilution chamber includes a draw tube to supply a solution from a container. The dilution chamber also includes a device to control an amount of liquid in the dilution chamber. The dilution chamber also includes a first injector to dilute the solution with the liquid and output a product within the dilution chamber. The dilution chamber also includes a second injector to add an ingredient to the product and output an enhanced product.

Additional features of the disclosed embodiments will be set forth in the description that follows, and, in part, will be apparent from the description or may be learned by the practice of the invention. The objectives and advantages of the disclosed embodiments will be realized and attained by the structure particularly pointed out within the written description and claims, as well as the drawings.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention.

FIG. 1 illustrates a system including a container having two motors according to the disclosed embodiments.

FIG. 2 illustrates an assembly having a mixer motor and a maintenance motor according to the disclosed embodiments.

FIG. 3 illustrates a flowchart for mixing and maintaining a solution according to the disclosed embodiments.

FIG. 4 illustrates a top view of a system having a dilution chamber and as assembly for mixing and managing the solution according to the disclosed embodiments.

FIG. 5 illustrates a dilution chamber according to the disclosed embodiments.

FIG. 6 is a transverse cross section of a preferred embodiment of an apparatus in accordance with the invention.

### DETAILED DESCRIPTION OF THE PREFERRED EMBODIMENTS

Reference will now be made in detail to embodiments of the present invention. Examples of the disclosed embodiments are illustrated in the accompanying drawings.

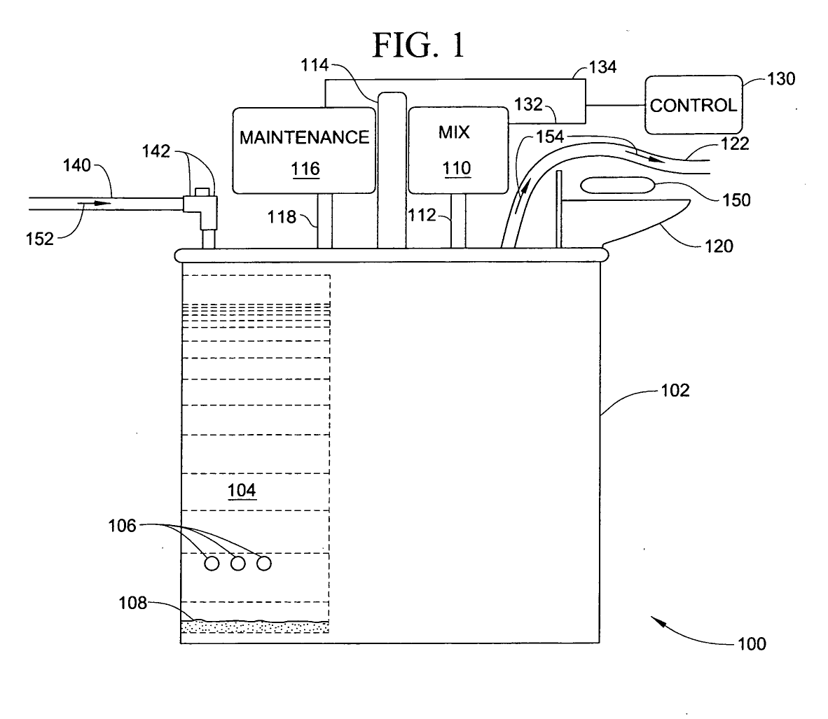

FIG. 1 depicts a system 100 for mixing and maintaining a solution according to the disclosed embodiments. System 100 includes container 102. Container 102 may be a container for holding liquids and mixed solutions, and may be of any shape, size, type, material and the like. Preferably, container 102 is a 55-gallon drum used to store a mixed powder and water solution 104 for commercial or industrial use. More preferably, container 102 is a steel drum used to hold solution 104 for storage and transport. Container 102 may be attached to a dilution system to prepare solution 104 for use. Alternatively, container 102 may be plastic. Container 102 also may be cylindrical in shape to allow rotors or paddles to rotate inside container 102.

Solution 104 is placed in container 102 and taken out for use in various applications or processes. Solution 104 preferably is a super-saturated or super-concentrated solution. For example, solution 104 may be a super-saturated powdered soap and water combination for use in carwashes. Solution 104 may be mixed in container 102 at the carwash, or may be delivered to the carwash.

Due to the super-saturated state of solution 104, powder particles 106 may form in solution 104. If heavier than solution 104, particles 106 may fall to the bottom of container 102 to generate residue 108. Residue 108 may act as sediment in container 102 by building up on the bottom as more particles 106 settle out. Alternatively, particles 106 may float to the top of solution 104. In this instance, residue 108 would form at the top of container 102. Particles 106 and residue 108, however, may be mixed back into solution 104 by system 100.

System 100 also includes mixing device 110 that is attached to agitator 112, and maintenance device 116 that is attached to agitator 118. Preferably, mixing device 110 and maintenance device 116 are motors that move agitators 112 and 118 to mix and agitate solution 104 inside container 102. Alternatively, mixing device 110 and maintenance device 116 may be pumps. Further, devices 110 and 116 may be any component, assembly or device that moves agitators 112 and 118 to mix solution 104. Agitators 112 and 118 may be attached to rotors, paddles, arms and the like, and also may be referred to as shafts. Separator 114 may be placed between mixing device 110 and maintenance device 116.

Although mixing device 110 and maintenance device 116 both mix solution 104, devices 110 and 116 are different. Mixing device 110 mixes powder 150 and water 152 to create solution 104. Powder 150 is placed in container 102 through intake 120. Powder 150 may be measured and placed in container 102 to ensure the proper consistency of solution 104. Water 152 may be put in container 102 from pipe 140 and control device 142. Control device 142 may be a valve to shut off the flow of water 152 into container 102.

Mixing device 110 operates agitator 112 to move in container 102 to generate solution 104. Mixing device 110 may be a motor to mixes at a high speed and having a high power output. For example, mixing device 110 may be a motor that runs at a power level of one-half (½) horsepower. Thus, agitator 112 moves within container 102 to mix up powder 150 and water 152. Because solution 104 may be super-saturated, more powder 150 may be placed in container 102 than water 152. For example, solution 104 may contain about 8-16 parts powder to about 1-2 parts water. More preferably, solution 104 may contain about 12 parts powder to about 1 part water.

Mixing device 110 operates to mix solution 104 for a period of time. For example, the period of time may be about 10-15 minutes. The period of time may vary according to the consistency desired for solution 104. The period of time also may be set within control 130. Control 130 may be a control circuit, switch and the like that turns mixing device 110 into an “on” state. Preferably, control 130 uses a toggle switch to turn mixing device 110 on and off.

For example, if mixing device 110 is a motor, then control 130 supplies power to the devices to mix solution 104. Coupling 132 connects control 130 to mixing device 110. Coupling 132 may be a power cord. Mixing device 110 mixes solution 104 at an increased power output level for the period of time, and then may turn off to reduce power consumption and not overexert mixing device 110.

After the period of time for mixing is finished, maintenance device 116 may operate according to a schedule set to maintain powder 150 in solution 104. The schedule, like the period of time for mixing, may be set in control 130, which is connected to maintenance device 116 by coupling 134. The schedule, however, differs from the period of time because it alternates turning maintenance device 118 on and off according to the schedule. Thus, maintenance device 118 may run for a certain amount of time, be off for a certain amount of time, and then be “on” again to agitate solution 104. Maintenance device 118 may run continuously according to the schedule.

Maintenance device 118 operates at a lower speed and power output level than mixing device 110. For example, maintenance device 118 operates at one-quarter (¼) horsepower. Thus, agitator 118 may appear to turn “slower” or less aggressively than agitator 112 coupled to mixer device 110. This difference in speeds is due to maintenance device 116 not trying initially to mix up the ingredients in solution 114. Instead, maintenance device 116 and its schedule are seeking to prevent the formation of particles 106 of residue 108.

In the above example, maintenance device 116 may be turned “on” for about 5 minutes. A switch or other indication is made at control 130 to execute maintenance operations. Agitator 118 rotates at a reduced speed when compared to agitator 112. Solution 104 is not allowed to stand long enough to allow particles 106 to settle. After the 5-minute activation, maintenance device 116 goes to an “off” state such that agitator 118 eventually stops. The intermittent operation of this feature of system 100 allows maintenance device 116 to rest and to prevent burn or damage to parts due to continuous use. Further, power requirements to maintain powder 150 in solution 104 may be reduced.

Thus, according to the disclosure above, accumulation of residue 108 may be prevented even in super-saturated solutions. Materials desiring a high concentration of powder 150 may be stored and kept until needed without the shortfalls of continuously running a motor to agitate solution 104.

Solution 104 may be drawn out from container 102 through draw tube 122. Drawn solution 154 may be parts of solution 104 that is being used. Alternatively, drawn solution 154 may be further diluted for use. Draw tube 122 may be a tube of any construction or material, and may be coupled to container 102 via a hole or insert into container 102. Preferably, the coupling of draw tube 122 and container 102 is sealed so as to not let in air or other materials to inadvertently mix with solution 104.

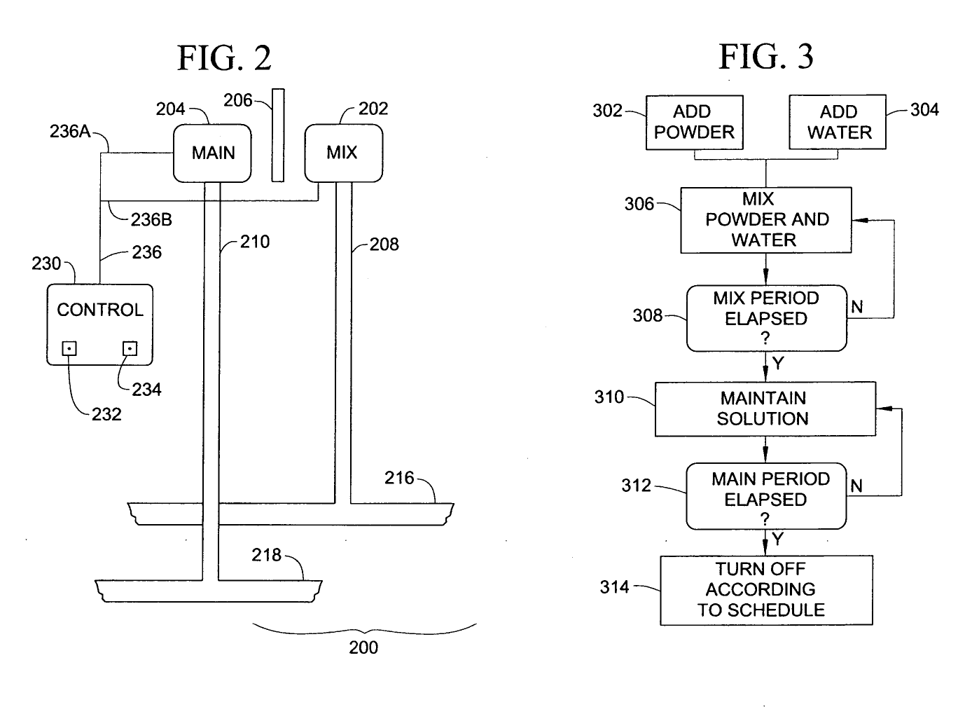

FIG. 2 depicts an assembly 200 having a mixing device 202 and a maintenance device 204 according to the disclosed embodiments. Assembly 200 may be put on a container, like container 102 shown in FIG. 1, to mix and maintain a solution. Assembly 200 also includes a spacer 206 that separates devices 202 and 204 from each other.

Mixing device 202 may operate like mixing device 110 in FIG. 1. Mixing device 202 is coupled to shaft 208 that are attached to arms 216. Arms 216 also may be referred to as propellers, paddles, blades and the like. Arms 216 may rotate about an axis created by shaft 208. Although FIG. 2 shows two arms for arms 216, any number of arms may be used according to the present invention. For example, arms 216 may include 3, 4 or 5 arms that rotate. Mixing device 202 provides the power to rotate shaft 208 and arms 216. Preferably, shaft 208 and arms 216 rotate in a circular pattern.

Maintenance device 204 may operate like maintenance device 116 in FIG. 1. Maintenance device 204 is coupled to shaft 210 that are attached to arms 218. Arms 218, like arms 216, may be referred to as propellers, paddles, blades and the like. Arms 218 may rotate about an axis created by shaft 210. Although FIG. 2 shows two arms for arms 218, any number of arms may be used according to the present invention. For example, arms 218 may include 3, 4 or 5 arms that rotate. Maintenance device 204 provides the power to rotate shaft 210 and arms 218. Preferably, shaft 210 and arms 218 also rotate in a circular pattern.

Thus, assembly 200 includes two devices 202 and 204 to mix and maintain a solution, or other blended ingredients. Preferably, devices 202 and 204 are motors. Assembly 200 may attach to the top of a container, such as a drum. Assembly 200 also may be removable so that a variety of containers may be used. For example, a super-saturated solution may be mixed by mixed device 202, shaft 208 and arms 216. The solution is in a container. Assembly 200 is removed from the container. The container is stored for later use.

During storage, the powdered ingredient, such as powdered soap, separates from the solution possibly due to being in a super-saturated state. The particles of the powder drift to the bottom of the container to build sediment or residue. Before use of the solution, assembly 200 may be re-attached to the container so that maintenance device 204 activates. Because the solution does not have to be mixed, high speed or aggressive rotation of arms 218 may not be needed. Maintenance device 204 runs at a lower power level so that burnout of a higher powered motor may not occur. Maintenance device 204 may operate on a schedule to slowly place the powder residue back into the super-saturated solution.

Although the above example was disclosed using a super-saturated solution, assembly 200 is not limited to use with only super-saturated solutions. For example, mixing device 202 may be used to mix a solution that may not be in a super-saturated or super-concentrated state. Thus, powder particles still may fall out of the solution and to the bottom of the container, but the amount of residue may not be significant. Assembly 200 still may be used favorably over assemblies with one motor or agitation device because lower power is used and the solution may not be overly agitated by the more aggressive mixing of mixing device 202. When the solution is to be used, maintenance device 204 may operate to just less aggressively agitate the solution for use.

Control 230 is coupled to mixing device 202 and maintenance device 204 by connector 236. Connector 236A is the part of connector 236 that attaches to maintenance device 204. Connector 236B is the part of connector 236 that attaches to mixing device 202. Connectors 236 may supply commands, instructions, power and the like to devices 202 and 204.

Control 230 also includes selectors 232 and 234. Selectors 232 and 234 may be switches, buttons, knobs and the like that allows a user to pick which device is to be operated. Preferably, selectors 232 and 234 are toggle switches. For example, if selector 232 is placed in an “on” position, then mixing device 202 rotates shaft 208 and arms 216. If selector 234 is placed in an “on” position, then maintenance device 204 rotates shaft 210 and arms 218. Control 230 may be a control circuit or other device that applies power to devices 202 and 204. Alternatively, control 230 may be a computer program having instructions to operate assembly 200 in accordance with the discussion above.

FIG. 3 depicts a flowchart for mixing and maintaining a solution according to the disclosed embodiments. Step 302 executes by adding powder to a container, such as container 102 in FIG. 1. The powder may be an ingredient used for commercial or industrial applications, such as powdered soap. Step 304 executes by adding water, or any other liquid, to the container. Water may be added via a pipe or tube connected to the container. Both the powder and the water may be added in specified quantities.

Step 306 executes by mixing the powder and the water to create a solution, such as solution 104 in FIG. 1. The solution may be a super-saturated or super-concentrated solution. The mixing is performed by a mixing device. The mixing device may be a motor. Alternatively, the mixing device may be a pump. Step 306 mixes the solution with an agitator, such as a shaft attached to arms that rotate around in the container. Step 306 may execute for a period of time to fully mix the solution, such as 15 minutes. Step 308 executes by determining whether the mixing period has elapsed. If no, then the flowchart returns to step 306 to keep mixing the solution.

If step 308 is yes, then step 310 executes by maintaining the solution. If the solution is in a super-saturated state, then step 310 maintains the powder in the solution by keeping it agitated. The maintaining is performed by a maintenance device. Preferably, the maintenance device is motor that rotates a shaft attached to arms. Step 310 may execute according to a schedule that includes an “on” and an “off” state. For example, the maintenance device may rotate for an on period and then stop for an off period.

Step 312 executes by determining whether the maintenance period has elapsed. If no, then the flowchart returns to step 310 to continuing maintaining the solution by mixing, or agitating, it using the maintenance device. If step 312 is yes, then step 314 executes by turning off the maintenance device according to the schedule. As disclosed above, the maintenance device may operate according to a schedule of “on” and “off” periods. The maintenance device turns off so as to not overburden the device and to prevent premature burnout or breakdowns. Further, the maintenance device may operate at a lower power output level because the solution, even if super-saturated, does not require vigorous agitation. Thus, as disclosed with FIGS. 1 and 2, two separate devices may be used to mix a solution of water and powder as well as maintain the water and powder in the solution.

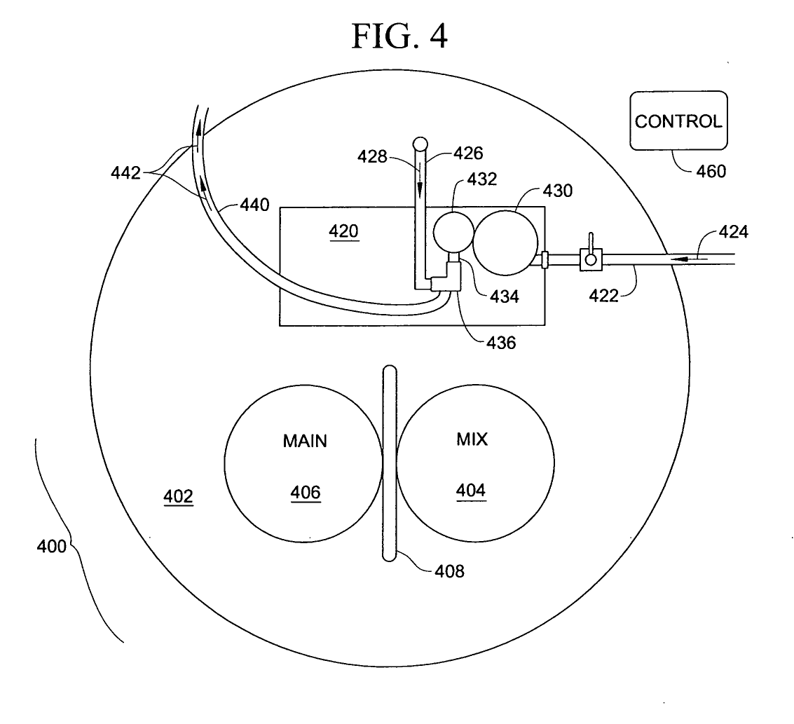

FIG. 4 depicts a top view of system 400 for mixing and maintaining a solution, and diluting the solution according to the disclosed embodiments. System 400 includes container 402, mixing device 404 and maintenance device 406. These features are analogous to the containers, mixing devices and maintenance devices disclosed above. For example, container 402 may contain powder and water that is mixed into a solution by mixing device 404. After the solution is created, maintenance device 406 operates to keep the powder in the solution, especially if the solution is in a super-saturated state. Spacer 408 separates mixing device 404 and maintenance device 406.

System 400 also includes a dilution chamber 420. Dilution chamber 420 may perform a “secondary” dilution of the solution in container 402. The operation may be referred to as a secondary dilution because the powder is diluted twice before being made available for use. Dilution chamber 420 is connected to a pipe 422 that supplies water 424. Valve 425 turns water 424 on and off to dilution chamber 420.

Draw tube 426 supplies solution 428 to dilution chamber 420. If the solution is super-saturated, buildup and residue of powder may be reduced because draw tube 426 is not very long, and may not have any low points or “elbows” to collect residue that clogs the tube. Instead of extending away from container 402, draw tube 426 extends up to dilution chamber 420. As solution 428 flows into chamber 420, water 424 is introduced for the dilution process. Preferably, solution 428 is diluted by water 424 such that a liquid product 442 is created. Liquid product 442 may be drawn out from dilution chamber 420 by feed tube 440.

Preferably, liquid product 442 includes two parts water 424 for one part solution 428. Liquid product 442 is not in a super-saturated state such that feed tube 440 stays open. Further, liquid product 442 is useable in a commercial or industrial application. For example, if solution 428 is a super-saturated soap solution, then liquid product 442 may be used in a car wash facility.

Within dilution chamber 420, weight-float device 430 controls the amount of water 424 supplied to dilution chamber 420. Weight-float device 430 may include a float coupled to a weight that shuts off water flow when dilution chamber 420 is filled to a certain level. Vacuum breaker 432 also provides control for the water flow and is coupled to weight-float device 430. Tube 434 connects vacuum breaker 432, and the water flow, with injector 436. Injector 436 is also connected to draw tube 426 to draw solution 428 from container 402. After solution 428 and water 424 are mixed, injector 436 may output liquid product 442 to feed tube 440.

Control 450 provides instructions and power to devices 404 and 406. Control 450 also may provide instructions to dilution chamber 420. For example, control 450 may instruct dilution chamber 420 when to perform dilution operations to generate liquid product 442. Dilution chamber 420 may be constructed of a stainless steel chamber. Alternatively, dilution chamber 420 may be constructed of plastic or any other material that encloses the features disclosed above.

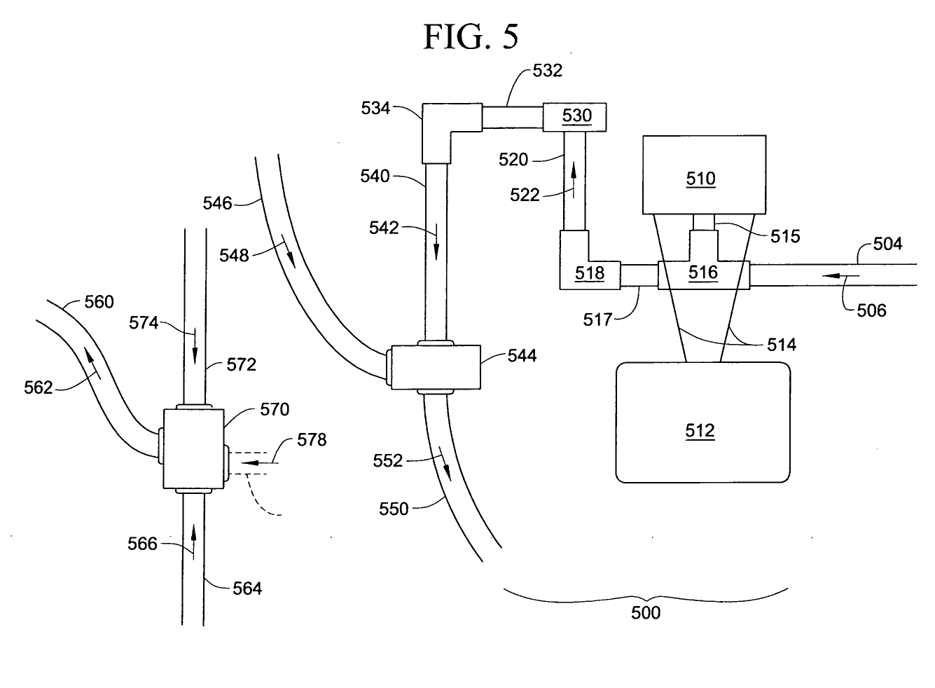

FIG. 5 depicts a dilution chamber 500 according to the disclosed embodiments. Dilution chamber 500 may be located on top of a container having solution mixed from powder and water. As disclosed above, the solution may be a super-saturated solution. Dilution chamber 500 takes the solution and uses it to generate a liquid product useable in commercial or industrial applications.

Dilution chamber 500 is coupled with a water supply by tube 504. Water 506 enters dilution chamber 500 through tube 504. The flow of water 506 is subject to stoppage by injector 516. Injector 516 is controlled by a weight-float device that includes weight 510 and float 512. Weight 510 may sit above tube 506 and injector 516. Float 512 sits below tube 506 and injector 516, and may be attached to weight 510 by couplings 514. Preferably, couplings 514 are chains that attach to weight 510 and float 512. Alternatively, couplings 514 may be string, a band and the like.

As float 512 moves upward within dilution chamber 500, the flow of water 506 may be prevented within injector 516. As dilution chamber 500 becomes empty, the flow of water 506 is allowed to pass through injector 516 to perform operations within dilution chamber 500. Injector 516 is coupled to attachment 518. Attachment 518 may be an elbow attachment that directs the flow of water 522 to vacuum breaker 530. Attachment 518 is attached to vacuum breaker by tube 520. Vacuum breaker 530 also may control the flow of water 522.

Vacuum breaker 530 is coupled to attachment 534 by tube 532. Attachment 534 also may be an elbow attachment that forwards water 542 to injector 544. As discussed above, water 542 may be added to solution 548 to produce a liquid product, such as liquid soap, for use in commercial or industrial applications. Injector 544 may be coupled to tube 540 and draw tube 546. Preferably, injector 544 includes two inputs and one output. Tubes 540 and 546 may serve the input ports of injector 544. Injector 544 outputs to dilution chamber 500.

Tube 546 supplies solution 548 to injector 544. As disclosed above, solution 548 may be a super-saturated or super-concentrated solution. Thus, residue and buildup may be prevented in the tubes and injectors of dilution chamber 500. Liquid product 552 is generated by solution 548 and water 542. This process may be called “secondary dilution” as the powder is diluted at this point in addition to the original dilution of mixing the powder with water for storage in container 500. Thus, liquid product 552 includes powder that is suspendable in water 542 and does not settle in any tubes or injectors.

Liquid product 552 may flow out from dilution chamber 500 through draw tube 560. For example, liquid product 552 may be drawn out after the secondary dilution is performed. Alternatively, additional steps or operations may be performed on liquid product 552 before being drawn into feed tube 560. Referring to FIG. 5, injector 570 may be connected to feed tube 560. Injector 570 may receive additional products or ingredients to produce enhanced product 562. Enhanced product 562 is different than liquid product 552 because something has been added to address a specific concern or solution.

For example, two detergents may be combined to produce an improved detergent. The improved detergent may include two different detergents in the form of two powders. According to the example, tube 564 draws solution 566 from dilution chamber 500. Solution 566 may be liquid product 552 that resides in dilution chamber 500. Although termed “solution,” solution 566 may include less concentration of powder, or detergent, than solution 548. Alternatively, solution 566 may be solution 548, drawn directly from the container by draw tube 546 and placed in dilution chamber 500. Thus, solution 566 includes a form of the powder, whether diluted or not, to make solution 548.

Tube 572 introduces another ingredient, or product, 574 to injector 570. For example, ingredient 574 may be powder that has not been diluted. Alternatively, ingredient 574 may be another powder to improve or enhance solution 566 to make enhanced product 562. This example may be especially pertinent when two different products are combined to address a specific application, such as two separate detergents that are combined to better perform cleaning operations such as enhanced product 562 that better attacks oily dirt and soils on cars or other surfaces. The demand for the enhancement may not be great enough to warrant the mixing and maintaining operations disclosed in FIGS. 1-4 above, so the combination of the detergents by injector 570 in dilution chamber 500 may be an alternative.

Injector 570 also may be connected to optional tube 576. Optional tube 576 may supply optional ingredient, or product, 578 to enhanced product 562. As disclosed above, the combination of different products, such as powders, may produce specifically desired results. Thus, dilution chamber 500 may allow further enhancement or modification of solution 548 drawn from a container at the container, or at least within close proximity to the container.

As a result, the probability of clogging up tubes, lines, injectors and the like by transporting super-saturated solution over a distance may be reduced. Injectors and tubes may be replaced, removed or changed within dilution chamber 500, and not at different machines in different locations. Further, one batch of the mixed solution may be used to produce a variety of liquid or enhanced products without the need for separate containers to store each variety.

Thus, according to the disclosed embodiments, the present invention allows the mixture of water and powder to form a solution that is stored in a container. Preferably, the powder is powdered soap or detergent and the container is a drum for storage of the solution. The solution is a super-saturated solution susceptible to particles forming residue or sediment within the container. The mixing of the powder and water is performed by a mixing device that operates an agitator within the container. Preferably, the mixing device is a motor that rotates a shaft having arms to mix the powder and water into the solution. The mixing device operates for a period, such as 15 minutes, and then turns off.

After the solution is mixed, it may need to be further agitated to prevent the formation of residue or sediment. The amount of agitation to maintain the solution in its current state, however, may be less than that needed for the initial mixing. Thus, a maintenance device is provided in conjunction with the mixing device. Both devices may be separated by a spacer and are located on an assembly attached to the container of solution.

The maintenance device also operates an agitator. Preferably, the maintenance device also is a motor that rotates a shaft having arms. The maintenance device, however, operates at a lower power output level than the mixing device. Thus, the solution is not subject to aggressive agitation, but just enough to maintain the solution. The feature allows the solution to be maintained without putting undue stress on one motor. Further, lower power requirements may be realized. The maintenance device may operate according to a schedule, where it operates the agitator for an amount of time, and then stops for an amount time before turning on again. Preferably, the maintenance device operates for 5 minutes and then is off for 5 minutes.

The disclosed embodiments also may include a dilution chamber connected to the container to draw out the solution and dilute it into a liquid product useable in commercial or industrial applications. The dilution chamber may reside on top of the container of solution and is connected to a tube to supply water and a tube to draw out the solution. The dilution chamber may include a device to control the flow of water into the chamber, and control the amount of water used to dilute the solution.

The solution and water are mixed together within the chamber. If the solution is in a super-saturated state, then the dilution, also referred to as secondary dilution, suspends the powder in a less concentrated state that reduces the likelihood of clogging or settling in tubes, connectors and injectors. Further, the less concentrated solution may be available for industrial and commercial applications without having to use different dilution assemblies.

The dilution chamber also allows additional ingredients or products to be introduced in the resulting liquid product subsequent to the secondary dilution. For example, another detergent may be added to enhance the detergent within the solution. Thus, the end product may be modified to address a specific application or problem without costly or complicated assemblies elsewhere. The dilution chamber may use three or four connection injectors to combine the ingredients and solutions.

In addition, although the above description discloses water as the liquid to combine with the powder, it may be appreciated that any liquid may be used with the disclosed embodiments. The solution may be comprised of a variety of ingredients, including multiple powders and liquids that are stored and maintained according to the present invention. Further, the solution may comprise two liquids, where one liquid is heavier than the other, and may be prone to settling within the container. In this instance, the maintenance device may not have to operate for as long of a period to prevent settling of the heavier liquid.

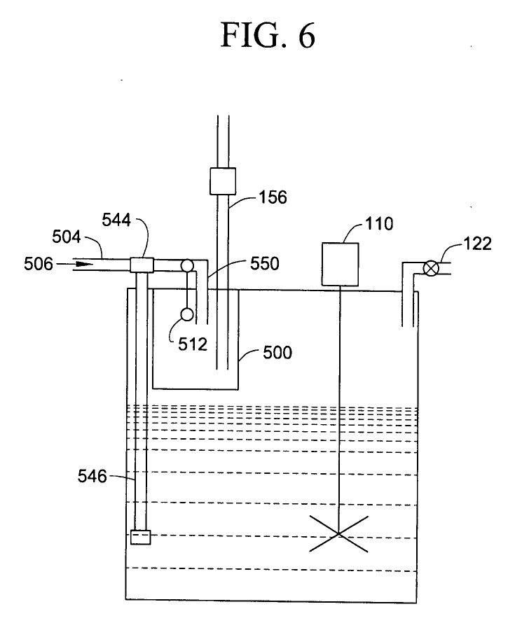

FIG. 6 is a transverse cross section of a preferred embodiment. As illustrated in FIG. 6, the dilution container 500 is suspended in the larger container for convenience, but it may be separate. The mixer 110 maintains the solid powders suspended in the solvent in the larger container whereby the composition in the solvent is the same as that of the powered (or liquid super concentrate, when used). When the float 512 detects a low level of liquid in the dilution chamber 500, water is provided to the HydroMinder 544 to draw super concentrated liquid from the larger container into the dilution container 500 while diluting it further. Preferably, the degree of dilution is such that the solution in the dilution container 500 does not require constant agitation to maintain the components in solution. Thus, the solution in the dilution container, while still concentrated has the same composition as that of the larger container. The contents of the dilution container are then diluted to the final concentration and provided to the user through outlet 156. The tube 546 is preferably of small diameter whereby it is always full such that it provides solution to the venture 544 almost immediately. As well, a filter may be provided at the bottom of tube 546 to prevent entry of clogging materials.

Those skilled in the art will appreciate that various modifications and variations can be made in the above examples of the present invention provided above without departing from the spirit and scope of the claimed invention. Thus, it is intended that the present invention covers the modifications and variations of the disclosure provided that they come within the scope of the claims and their equivalents.

I claim:

1. A storage system for a blended powder and liquid solution, the storage system comprising:
a container to store the blended solution;
a mixing device attached to the container to mix powder and liquid with a first agitator to form the blended solution, wherein the mixing device is to run at a first power level for a period of time; and
a maintenance device having a smaller power output than the mixing device and attached to the container to maintain the powder in the blended solution with a second agitator, wherein the maintenance device is to operate according to a schedule at a second power level,
wherein the second power level is lower than the first power level.

2. The storage system of claim 1, wherein the mixing device includes a motor.

3. The storage system of claim 1, wherein the container comprises a drum.

4. The storage system of claim 1, wherein the powder comprises powdered soap.

5. The storage system of claim 1, wherein the schedule includes an intermittent operation of the maintenance device.

6. The storage system of claim 5, wherein the maintenance device includes a motor.

7. The storage system of claim 1, further comprising a dilution chamber connected to the container.

8. The storage system of claim 7, wherein the dilution chamber is configured to dilute the blended solution.

9. The storage system of claim 1, further comprising a control coupled to the mixing device and the maintenance device.

10. A method for mixing and maintaining a solution, the method comprising:
mixing a solute and a solvent in a container to form in part a solution of said solute and in part a suspension of said solute in said solvent such that the composition of said solution and said suspension of said solute in said solvent is the same as that of said solute; and
transferring a portion of said solution of said solute and said suspension of said solute to a dilution chamber.

11. The method of claim 10, further comprising diluting said solution of said solute and said suspension of said solute in said dilution chamber.
